(19) United States
(12) Patent Application Publication
(10) Pub. No.: US 2023/0120721 A1
(43) Pub. Date: Apr. 20, 2023

(54) FLUID PURIFICATION SYSTEMS AND METHODS

(71) Applicant: Next Generation Filtration Systems, LP, Pittsburgh, PA (US)

(72) Inventor: Peter M. Canovali, Wexford, PA (US)

(21) Appl. No.: 17/505,053

(22) Filed: Oct. 19, 2021

(51) Int. Cl. B01D 35/18; B01D 24/10; B01D 53/26; B01D 1/00; B01D 17/04

(52) U.S. Cl. CPC B01D 35/185; B01D 24/10; B01D 53/26; B01D 1/0082; B01D 17/042; B01D 1/0011; F16N 39/06

(57) ABSTRACT

Apparatuses and methods for improved operation of a fluid purification system. The apparatuses and methods may include an evaporator chamber and a filter chamber and include directing compressed air into the air inlet of an evaporator chamber, drying the compressed air before directing the compressed air into the air inlet of the evaporator chamber, reducing pressure at the air outlet of the evaporator chamber to less than atmospheric pressure, collecting material exiting the evaporator chamber through the air outlet in a particulate bottle, and drawing air from the particulate bottle into the air inlet of the evaporator chamber.

### CROSS-REFERENCE TO RELATED APPLICATIONS

None.

### FIELD OF THE INVENTION

The present invention is directed to a fluid purification system having improved moisture evaporation and improved operation and maintenance. In particular, the fluid purification operational systems and methods are directed to systems and methods that provide improvements over prior fluid purification systems.

### BACKGROUND OF THE INVENTION

Fluid purification apparatuses, systems and methods with which the present fluid purification operational apparatuses, systems and methods may be used are disclosed in U.S. Pat. Nos. 7,976,702; 8,216,460; 8,246,820; 8,409,435; 8,623,218; and 8,623,219. U.S. Pat. No. 7,976,702 discloses an apparatus having particulate filter and evaporator sections, a ridged surface heater disposed in the evaporator section, an evaporation tube positioned around the heater, and an air inlet and an air outlet in the evaporator section. U.S. Pat. No. 8,216,460 discloses a manifold coupled to the particulate filter section or the evaporator section to direct flow through the apparatuses as desired. U.S. Pat. No. 8,246,820 discloses a fluid purification device having a narrow fluid heating channel between the inner surface of the evaporation tube and the heater. U.S. Pat. No. 8,409,435 discloses a pump in fluid communication with the outlet of a fluid purification apparatus. U.S. Pat. No. 8,623,218 discloses energizing the fluid purification apparatus based on the pressure entering or in the fluid purification apparatus. U.S. Pat. No. 8,623,219 discloses a level sensor that regulates operation of the fluid purification apparatus.

It is believed that certain fluid purification apparatuses, systems and methods would benefit from improved designs.

For example, fluid purification apparatuses, systems and methods could benefit from having separate evaporator chambers and filter chambers. With such separation, the chambers may, for example, be combined in various combinations such as having two evaporator chambers feed a single filter chamber or improved placement of one or more evaporator chambers and one or more filter chambers in confined spaces.

Fluid purification apparatuses, systems and methods could also benefit from pressurized or forced air flow through the evaporator chamber. For example, a fan, air pump, or compressed air may be fitted to the air inlet of the evaporator chamber. A fan, air pump, or compressed air may alternatively or in addition be employed at the air outlet of the evaporator chamber to draw air out of the evaporator chamber.

A dryer, such as a refrigeration unit or a desiccant filter may be applied at the air inlet of the evaporator section to remove moisture from the air entering the inlet and thus aid in the evaporation of water from the fluid by moving dry air able to absorb moisture through the evaporator chamber.

A cap that can be quickly and easily removed and replaced would be beneficial and a cap that can be easily aligned with the appropriate filter or evaporator section would also be beneficial.

Accordingly, it is believed that there is a need for improved the fluid purification devices, systems and methods that are described herein.

### SUMMARY OF THE INVENTION

The present invention is directed to systems, methods and apparatuses for purifying fluids. In accordance with one embodiment of the present fluid purification invention, there is provided a filter chamber, an evaporator chamber in fluid communication with and separate from the filter chamber, and a particulate bottle in fluid communication with the evaporator chamber through a tube. The filter chamber has a removable cap sealed to the filter chamber by a housing clamped into a first annular groove on an outer surface of the cap and a second annular groove on an outer surface of the filter chamber and a gasket that is disposed between the clamped housing and the first and second annular grooves. The evaporator chamber has a cavity to receive fluid, an air inlet and an air outlet. The tube is coupled to the air outlet of the evaporator chamber and arranged such that fluid and solid material that exit the air outlet of the evaporator chamber are deposited in the particulate bottle. Compressed air is directed into the air inlet of the evaporator chamber and a dryer is disposed between the air inlet of the evaporator chamber and a compressed air source.

Another embodiment, a fluid purification apparatus includes a filter chamber, an evaporator chamber in fluid communication with and separate from the filter chamber, and a particulate bottle in fluid communication with the evaporator chamber through a tube. In that embodiment, the filter chamber has an inlet, an outlet, and a filter media between the inlet and the outlet. The evaporator chamber is in fluid communication with and separate from the filter chamber and the evaporator chamber has a cavity to receive fluid and air, an air inlet, an air outlet, a fluid inlet, and a fluid outlet. The particulate bottle is in fluid communication with the evaporator chamber air inlet and in fluid communication with the evaporator chamber air outlet. A dryer is disposed between the particulate bottle and the air inlet of the evaporator chamber and at least one air flow generating device is located between the evaporator chamber air outlet and the evaporator chamber air inlet.

An embodiment of a method of purifying fluid includes directing compressed air into the air inlet of an evaporator chamber, drying the compressed air before directing the compressed air into the air inlet of the evaporator chamber, reducing pressure at the air outlet of the evaporator chamber to less than atmospheric pressure, collecting material exiting the evaporator chamber through the air outlet in a particulate bottle, and drawing air from the particulate bottle into the air inlet of the evaporator chamber.

The present filtration apparatuses and methods provide advantages that may include improved fluid flow from a pressure reducing filtration apparatus in a pressurized fluid system.

Accordingly, the present invention provides solutions to the shortcomings of prior filtration apparatuses, systems, and methods. Those of ordinary skill in fluid purification will readily appreciate that those details described above and other details, features, and advantages of the present invention will become further apparent in the following detailed description of the preferred embodiments of the invention.

### BRIEF DESCRIPTION OF THE DRAWINGS

The accompanying drawings, which are incorporated herein and constitute part of this specification, include one or more embodiments of the invention, and together with a general description given above and a detailed description given below, serve to disclose principles of the invention in accordance with a best mode contemplated for carrying out the invention.

FIG. 1 is a cross-sectional view of an embodiment of a fluid purification apparatus;

FIG. 2 is a cross-sectional view of an embodiment of a separate filter chamber of fluid purification apparatus;

FIG. 3 is a cross-sectional view of an embodiment of a separate evaporator chamber of fluid purification apparatus; and

FIG. 4 is a flowchart illustrating a method of purifying fluid.

### DETAILED DESCRIPTION OF THE INVENTION

Reference will now be made in detail to the preferred embodiments of the present invention, examples of which are illustrated in the accompanying drawings. It is to be understood that the figures and descriptions of the present invention included herein illustrate and describe elements that are of particular relevance to the present invention, while eliminating, for purposes of clarity, other elements found in typical systems with which fluid filtration apparatuses, systems, and methods are employed.

Any reference in the specification to “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment. References to “or” are furthermore intended as inclusive so “or” may indicate one or another of the ored terms or more than one ored term.

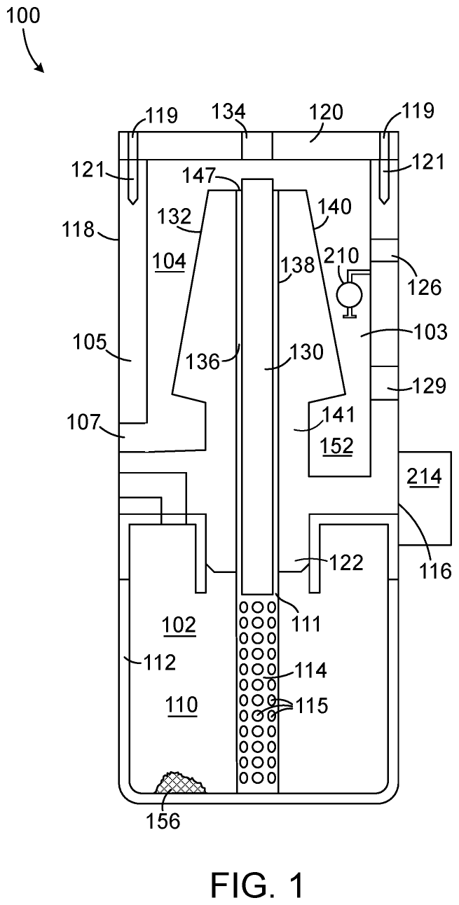

FIG. 1 illustrates a cross-sectional view of an embodiment of a fluid purification apparatus 100. The fluid purification apparatus 100 includes a filter chamber 102, an evaporator chamber 104, and a filter base 105.

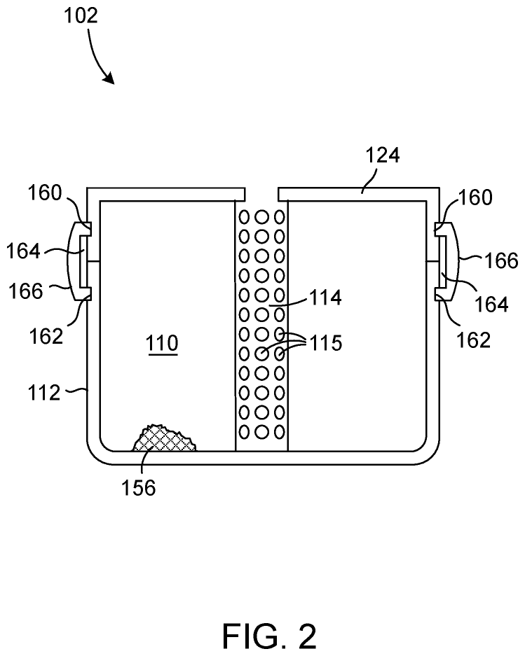

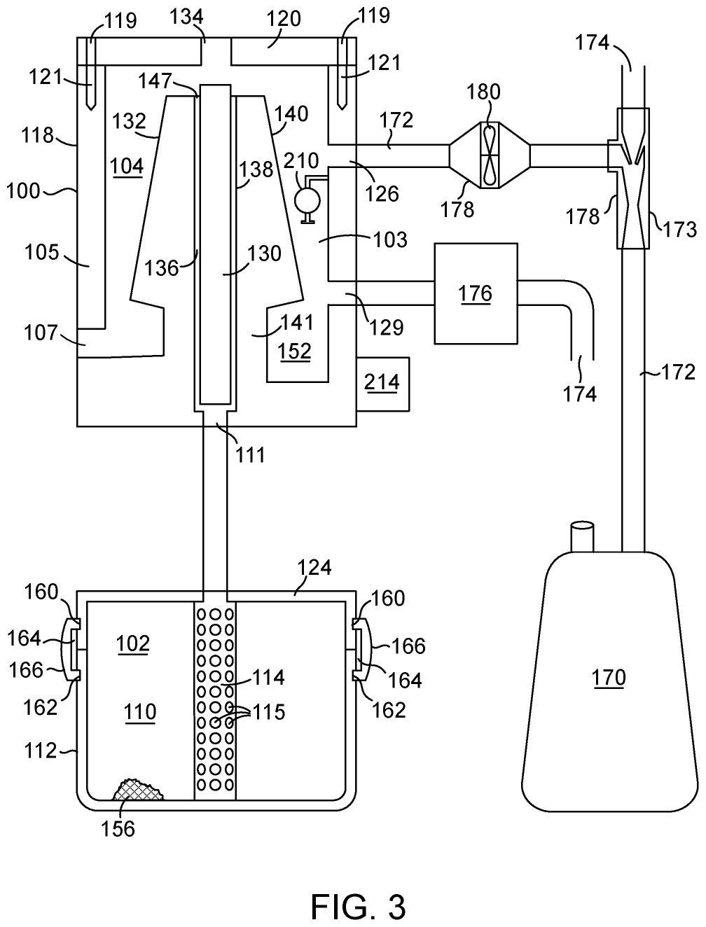

The filter chamber 102 and evaporator chamber 104 may be connected so as to form a single unit, as is illustrated in FIG. 1, or the filter chamber 102 and evaporator chamber 104 may be separate units with fluid flowing between the filter chamber 102 and evaporator chamber 104. Fluid may flow between the filter chamber 102 and evaporator chamber 104 as desired, including by use of a pump or gravity, and in whatever order, evaporator chamber 104 to filter chamber 102 or filter chamber 102 to evaporator chamber 104, is desired. A separate filter chamber 102 may be configured as shown in FIG. 2 and a separate evaporator chamber 104 may be configured as illustrated in FIG. 3.

Fluid communication between separate filter chambers 102 and evaporator chambers 104 may be through, for example, one or more tubes or other pipes, conduits, or channels. When the filter chamber 102 and evaporator chamber 104 are separate, two or more evaporator chambers 104 may be in fluid communication with a single filter chamber 102, two or more filter chambers 102 may be in fluid communication with a single evaporator chamber 104, or the filter chambers 102 and evaporator chambers 104 may be interconnected in any numbers desired.

The filter chamber 102 of FIG. 1 includes a filter cavity 110 and a filter canister 112. A removeable filter chamber cap 124 or other access may be provided to enable simple change of a filter media 156 placed in the filter cavity 110. In certain embodiments, such as the fluid purification device illustrated in FIG. 1, a filter chamber cap 124 may not be provided and the filter media 156 may be accessed, for example, by removing the filter canister 112 from the base 105. Where a filter chamber cap 124 is used, the filter chamber cap 124 may be formed anyway desired, including using threads or by using a groove and clamped housing system.

In an embodiment that is illustrated in FIG. 2, the cap 120 and filter canister 112 are placed adjacent to one another coaxially and the filter chamber cap 124 and filter canister 112 include parallel grooves 160 and 162, respectively. At least one gasket 164 may cover the grooves 160 and 162 and the line or area where the adjacent filter chamber cap 124 and filter canister 112 meet and abut one another. A housing, band, or clamp 166 is placed in the filter chamber cap 124 and filter canister 112 grooves 160 and 162 and extends across the grooves 160 and 162 over at least a portion of the gasket 164. The housing 166 may be multipart and the housing 166 or multiple housing sections may be held in place by nuts and bolts or otherwise as desired.

The filter media may be accessed, for example, by unscrewing the filter canister 112 from the base 105, unscrewing the cap 124 from the filter canister 112, removing band 166 and gasket 164, or otherwise disconnecting the filter canister 112 from its cap 124, base 105 or other closure connection. Once the filter canister is opened, the filter media 156 may be removed therefrom and a replacement filter media 156 may be placed in the filter canister 112. The filter canister 112 may be closed by replacing the cap 124 or by screwing or otherwise attaching the filter canister 112 to the base 105.

The filter chamber 102 of FIG. 1 further includes a perforated tube 114, having perforations 115. The perforated tube 114 is situated to pass through a central cylindrical opening in the filter media 156 in the embodiment illustrated in FIG. 1, such that fluid may flow into the filter chamber 102, through the filter media 156, into the perforated tube 114 and pass from the perforated tube 114 into the evaporator chamber 104 through an inner-chamber opening 111. Alternatively, fluid may pass from one or more evaporator chambers 104 into the filter chamber 102 and fluid may pass between chambers 102 and 104 by way of tubing or another apparatus that provides fluid communication between the chambers 102 and 104. In embodiments, the filter chamber 102 is a particulate filter chamber and functions to remove particulates from the fluid and the evaporator chamber 104 removes water, fuel or other volatiles from the fluid.

The evaporator chamber 104 of FIG. 1 includes a heater wiring inlet 134, a heater 130, an evaporation tube 132, an evaporator gas inlet 129, and an evaporator gas outlet 126. A level sensor 210, such as a float switch or other level sensor, and a temperature sensor 214, such as a high temperature switch or other temperature sensor, may be disposed in a cavity 103 of the evaporator chamber 104 or positioned near the evaporator chamber 104. The temperature sensor may be coupled, through wire or wirelessly, to a controller to energize and de-energize the heater to maintain a desired temperature range where the temperature sensor 214 is located in or on the evaporator chamber 104. The float switch or level sensor may also energize and de-energize the heater 130, possibly through the same or a second controller.

In the embodiment illustrated in FIG. 1, the evaporation tube 132 is fitted around the heater 130 and fluid passes from the filter chamber 102 into the evaporator chamber 104 through a fluid heating channel 136 formed between the heater 130 and an inner surface 138 of the evaporation tube 132. The heated fluid flows out from the evaporator end 147 of the evaporation tube 132 after it passes through the fluid heating channel 136. The heated fluid then passes over an outer surface 140 of the evaporation tube 132 and into the evaporation chamber 104 where certain volatiles of the heated fluid, such as water and uncombusted fuel, turn to a gas and are vented from the evaporator chamber 104 through the evaporator gas outlet 126.

The evaporation tube 132 may be in contact with the divider 116 and may furthermore be attached to the divider 116 or formed with the divider 116. The evaporation tube 132 may also be shaped with a conically shaped outer surface 140 that is pinched 141 near where the evaporation tube 132 meets the divider 116. Fluid passing out of the fluid heating channel 136 may flow along the outer surface 140 of the evaporation tube 132 into a fluid reservoir 152 in the evaporator chamber 104.

The base 105 includes the divider 116 that at least partially separates the filter chamber 102 from the evaporator chamber 104. The base 105 may also include a circular wall 118 that extends from the divider 116 to at least partially enclose the evaporator chamber 104. That circular wall 118 may form the evaporator filter canister 112. An evaporator chamber cap 120 may be attached to the filter canister 112 to cover and provide access to the evaporator chamber 104. The evaporator chamber cap 120 may be attached to the base 105 or filter canister 112 as desired and may, for example, be attached by way of screws extending through holes 119 in the evaporator chamber cap 120 and threaded into threaded holes 121 formed in the circular wall 118 or a groove 160 and 162 and housing 166 arrangement, such as is illustrated in FIG. 2.

A threaded circular portion 122 may also extend from the divider 116 portion of the base 105, opposite the circular wall 118, for attachment of the filter canister 112.

The fluid purification apparatus 100 may be used in various applications including filtration of lubricants in engines of various types and in pressurized fluid applications such as hydraulic fluid system. Oil, hydraulic fluid, or another fluid may pass through the filter chamber 102 and the evaporator chamber 104 in series and in either order or may pass through the filter chamber 102 or the evaporator chamber 104 individually or in parallel.

FIG. 2 illustrates an embodiment of a filter chamber 102 separate from an evaporator chamber 104 and to be placed in fluid communication with at least one evaporator chamber 104. The filter chamber 102 can be any container that can hold filter media 156 and oil, hydraulic fluid, or another hydrocarbon-based fluid. The filter chamber 102 may be jar shaped or otherwise shaped as desired and may include a filter chamber cap 124 that may be removed from the filter chamber 102 to permit the filer media 156 to be removed from the filter chamber. A replacement filter media may also be placed in the filter chamber 102, or oil hydraulic fluid or another hydrocarbon-based fluid may be removed from or added to the filter chamber 102 when the filter chamber cap 124 is not attached to the filter chamber 102.

The filter media 156 may be flat, cylindrical, or another desired shape and may be contained in an appropriately shaped filter chamber 102. The fluid to be filtered (e.g., oil, hydraulic fluid, or another hydrocarbon-based fluid) may pass through the filter media in either direction (e.g., inside to outside, outside to inside, right to left, or left to right) desired to capture solid and semisolid materials in the filtered fluid in the filter media 156. When the filter media 156 has captured significant material from the filtered fluid, the filter media 156 may be replaced with a replacement filter media and, if desired, fluid may be drained from the filter chamber 102 through the filter chamber cap 124.

FIG. 3 illustrates an embodiment of an evaporator chamber 104 separate from a filter chamber 102 and to be placed in fluid communication with one or more filter chambers 102. In the embodiment illustrated in FIG. 3, the evaporator chamber 104 is connected to a pressurized air source 174 in fluid communication with the evaporator chamber 104 air inlet 129. The evaporator chamber 104 air outlet 126 in that embodiment is in fluid communication with a particulate bottle 170 through a tube 172, such that any particulates exiting the evaporator chamber through the outlet 126, including the fluid that circulates through the evaporator chamber 104, may be captured in the particulate bottle 170.

In certain embodiments, the particulate bottle 170 may be connected in fluid communication with the evaporator chamber 102 inlet 129 such that air is circulated from the particulate bottle 170 into the evaporator chamber 104 and then returned to the particulate bottle 170. Such an arrangement may include an air flow propellant and moisture removal. For example, in one embodiment the evaporator chamber 104 particulate bottle 170 system may comprise a closed system, sealed or partially sealed from ambient air, wherein air pressure is drawn from the evaporator chamber 104 by an air pump or air is driven into the evaporator chamber 104 by an air pump and a desiccant air dryer 176 dries the air before the air is dispersed into the evaporator chamber 104.

Such a desiccant filter dehumidifying moisture removal device 176 is illustrated in FIG. 3. The dehumidifying moisture removal device 176 may, alternatively, be a refrigeration device or another desired moisture removal device and may be provided in the air stream entering the evaporator chamber 104 through the inlet 129. A vacuum creating device 178 may be provided to increase airflow out of the evaporator chamber 104 outlet 126. That vacuum may be created by means of a Venturi effect, such as produced by a vacuum ejector 173 connected to a compressed air source 174. That vacuum may also be created by, for example, compressed air flowing near and away from the evaporator chamber 104 outlet 126, a fan 180, or any type of air pump or vacuum device desired.

In embodiments, the heater 130 may be installed through the filter chamber cap 124 or a surface of the evaporator chamber 104 for easy removal and insertion. For example, the heater 130 may be inserted through a heater orifice in the evaporator chamber 104 and retained in place by a compression nut or other quick sealing connecting and disconnecting apparatus or method. In that way the heater 130 may be removed to be cleaned, checked, tested, replaced, or removed for any desired reason and that heater 130 or another heater 130 may be reinstalled in the evaporator chamber 104 through that heater orifice. The heater 130 may alternatively be removed from the evaporator to provide access to the evaporator chamber 104 to drain fluid therefrom, clean the evaporator chamber 104, or another desired purpose.

In various embodiments, a heater wiring inlet may not be required through the evaporator chamber 104. Rather, the heater 130 may extend through the evaporator chamber 104 and heater wires may be accessible external to the evaporator chamber 104. The temperature sensor or controller may be disposed in the vicinity of where the fluid is discharged into the evaporator chamber 104, for example near the evaporator end 147 of the evaporation tube 132 as illustrated in FIG. 3 to provide an accurate indication of the temperature of the fluid at the location where evaporation begins in earnest.

In an embodiment of a fluid purification device, the filter chamber 102 has a removable cap 124 sealed to the filter chamber 102 by clamping the housing 166 into a first annular groove 160 on an outer surface of the filter chamber cap 124 and a second annular groove 162 on an outer surface of the filter chamber 102. A gasket 164 may be disposed between the clamped housing 166 and the first and second annular grooves 160 and 162, extending across the juncture of the filter chamber 102 and the filter chamber cap 124. The housing 166 ring may be pressed into the grooves 160 and 162 over the gasket 164 and clamped in place to seal the filter chamber cap 124 and the filter chamber. The housing 166 may, for example, be retained in place in the grooves 160 and 162 by screws extending though a first half of the housing 166 into a second half of the housing 166.

One or more evaporator chambers 104 are in fluid communication with and separate from the filter chamber 102 in certain embodiments. The evaporator chambers 104 have a cavity 103 to receive fluid, a fluid inlet 111, and a fluid outlet 107 with the fluid coming from a machine, such as an engine, and returning to that machine after passing through an evaporator chamber 104 and the filter chamber 102. The evaporator chambers 104 also have an air inlet 129 and an air outlet 126 through which air may pass to dry or remove moisture from the fluid.

In embodiments, a particulate bottle 170 is in fluid communication with the evaporator chamber 104 through a tube 172 that is connected to the air outlet 126 of the evaporator chamber 104 and arranged such that fluid and solid material that exit the air outlet 126 of the evaporator chamber 104 are deposited in the particulate bottle 170.

In addition, compressed air is directed into the air inlet 129 of the evaporator chamber 104 and a dryer 176 is disposed between the air inlet 129 of the evaporator chamber 104 and a compressed air source. The compressed air may be plant or building compressed air or may be a fan 180 or other air propellant provided for the fluid purifying unit, for example. The dryer may be a desiccant type or a refrigerated dehumidifier provided for the fluid purification device, for example.

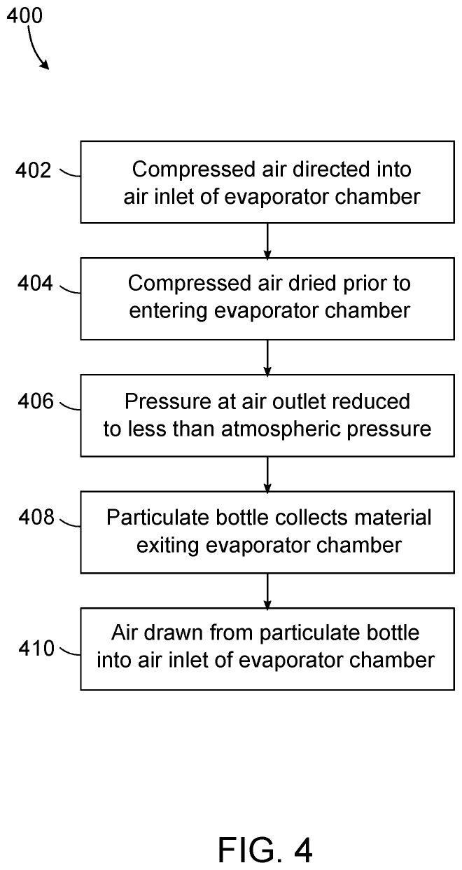

FIG. 4 illustrates a method of purifying fluid 400. That method includes directing compressed air into the air inlet 129 of an evaporator chamber 104 at 402. Compressed air is air under a pressure that is greater than atmospheric pressure. At 404, the compressed air is dried prior to the compressed air entering the evaporator chamber 104. At 406, pressure at the air incident at the air outlet 126 of the evaporator chamber 104 is reduced to less than atmospheric pressure to further increase flow through the evaporator chamber 104. At 408, collecting material exiting the evaporator chamber 104 through the air outlet 126 in a particulate bottle 170. At 410, drawing air from the particulate bottle 170 into the air inlet 129 of the evaporator chamber 104. Such drawing of air from the particulate bottle may be accomplished using a pressure increasing apparatus increasing the pressure of air moving from the particulate bottle 170 to the air inlet 129 of the evaporator chamber 104.

The method of purifying fluid also includes receiving fluid at a fluid inlet of the evaporation chamber and discharging low water content fluid from a fluid outlet in the evaporator chamber. The fluid that is discharged from the evaporator chamber may flow through a filter media in a filtration chamber that may be separate and in fluid communication with the evaporator chamber. That dried fluid may then be discharged into a process mechanism, such as an engine or equipment used in a process, or anywhere desired.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments. Thus, while certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

What is claimed is:

1. A fluid purification apparatus, comprising:
a filter chamber having a removable cap, an oil inlet, an oil outlet, and a filter media between the oil inlet and oil outlet, the filter media removable through the removable cap;
an evaporator chamber in fluid communication with and separate from the filter chamber, the evaporator chamber having a cavity to receive fluid, an air inlet, and an air outlet;
a particulate bottle in fluid communication with the evaporator chamber through a tube, the tube coupled to the air outlet of the evaporator chamber and arranged such that fluid and solid material that exit the air outlet of the evaporator chamber are deposited in the particulate bottle;
compressed air directed into the air inlet of the evaporator chamber;
a dryer disposed between the air inlet of the evaporator chamber and a compressed air source; and
the compressed air coupled to the tube coupled to the air outlet of the evaporator chamber to direct air out of the air outlet.

2. The fluid purification apparatus of claim 1, further comprising a second evaporator chamber in fluid communication with the separate filter chamber.

3. The fluid purification apparatus of claim 1, wherein the compressed air directed into the air inlet of the evaporator chamber and the compressed air coupled to the tube coupled to the air outlet of the evaporator chamber are provided by the compressed air source.

4. The fluid purification apparatus of claim 1, wherein the particulate bottle is in fluid communication with the evaporator chamber air inlet.

5. The fluid purification apparatus of claim 4, wherein the evaporator chamber and particulate bottle form a sealed system;
the evaporator chamber being sealed except for its air inlet and air outlet;
the particulate bottle being sealed except where it is piped to the evaporator chamber air inlet and where it is piped to the evaporator chamber air outlet; and
the dryer being provided in a line connecting the particulate bottle to the air inlet of the evaporator chamber, the dryer depositing water removed from the air exterior to the evaporator chamber and particulate bottle sealed system.

6. The fluid purification apparatus of claim 1, further comprising:
a temperature sensor in the evaporator chamber sensing the temperature at the evaporator end of the evaporation tube; and
a controller coupled to the temperature sensor and coupled to the heater to energize the heater when the sensed temperature is below setpoint and to de-energize the heater when the sensed temperature is above setpoint.

7. The fluid purification apparatus of claim 6, wherein the temperature controller is packaged with the temperature sensor.

8. The fluid purification apparatus of claim 6, wherein the temperature controller is outside the evaporator chamber.

9. The fluid purification apparatus of claim 8, wherein the temperature controller receives wireless communication of the sensed temperature from the temperature sensor.

10. The fluid purification apparatus of claim 8, wherein the temperature controller is wired to the temperature sensor through the evaporator chamber to receive communication of the sensed temperature from the temperature sensor.

11. The fluid purification apparatus of claim 10, wherein the wire extending between the temperature sensor and the temperature controller extends through the evaporator chamber adjacent to the heater.

12. The fluid purification apparatus of claim 1, wherein the evaporator chamber has a removable evaporator cap; and
a gasket disposed to prevent leakage between the evaporator chamber and the evaporator cap.

13. A fluid purification apparatus, comprising:
a filter chamber having an inlet, an outlet, and a filter media between the inlet and the outlet;
an evaporator chamber in fluid communication with and separate from the filter chamber, the evaporator chamber having a cavity to receive fluid and air, an air inlet, an air outlet, a fluid inlet, and a fluid outlet;
a particulate bottle in fluid communication with the evaporator chamber air inlet and in fluid communication with the evaporator chamber air outlet;
a dryer disposed between the particulate bottle and the air inlet of the evaporator chamber; and
at least one air flow generating device located between the evaporator chamber air outlet and the evaporator chamber air inlet.

14. The fluid purification apparatus of claim 13, wherein the evaporator chamber fluid outlet is coupled to the filter chamber fluid inlet.

15. The fluid purification apparatus of claim 14, wherein one of oil and hydraulic fluid flows is to flow from the evaporator chamber fluid outlet to the filter chamber fluid inlet, the one of oil and hydraulic fluid flows is to flow from the filter outlet to a machine, and the one of oil and hydraulic fluid is to flow from the machine into the evaporator fluid inlet.

16. A method of purifying fluid, the method comprising:
directing compressed air into the air inlet of an evaporator chamber;
drying the compressed air before directing the compressed air into the air inlet of the evaporator chamber;
reducing pressure at the air outlet of the evaporator chamber to less than atmospheric pressure;
collecting material exiting the evaporator chamber through the air outlet in a particulate bottle; and
drawing air from the particulate bottle into the air inlet of the evaporator chamber.

17. The method of claim 16, further comprising directing fluid from a fluid outlet of the evaporator chamber into a filter chamber where the fluid passes through a filter media.

18. The method of claim 17, further comprising receiving fluid at a fluid inlet of the evaporator chamber at a fluid input.

19. The method of claim 18, further comprising a filtration device receiving fluid from the evaporator chamber fluid outlet.

20. The method of claim 16, further comprising discharging the fluid from the filtration device into a process mechanism.
